(19) United States
(12) Patent Application Publication
(10) Pub. No.: US 2009/0189869 A1
(43) Pub. Date: Jul. 30, 2009

(54) TOUCH PANEL INPUT DEVICE, CONTROL METHOD OF TOUCH PANEL INPUT DEVICE, MEDIA STORED CONTROL PROGRAM, AND ELECTRONIC DEVICE

(75) Inventor: Hirotomo Nishimura, Hadano-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/338,933

(22) Filed: Dec. 18, 2008

(30) Foreign Application Priority Data
Dec. 20, 2007 (JP) 2007-328378
Nov. 26, 2008 (JP) 2008-300524

(51) Int. Cl. G06F 3/041; G06F 3/033; G06K 15/00

(52) U.S. Cl. 345/173; 715/863; 358/1.12

(57) ABSTRACT

A touch panel input device 1 is provided which includes: a touch panel operating unit 100 including a display unit 110 displaying an image inquiring an operation, a touch panel 120 provided on a screen of the display unit 110, and a coordinate output unit 130 outputting touched coordinates on the touch panel 120; a panel display unit 212 displaying on the display unit 110 the image inquiring an operation and including a plurality of areas and a plurality of buttons in the areas; an area specifying unit 214 specifying the area including the coordinates at present; and a button specifying unit 216 validating the button through which the coordinates first or finally pass among the plurality of buttons included in the area before the movement when the coordinates are changed from the present area to the different area by movement on the touch panel 120 with a touched state maintained.

### CROSS REFERENCES TO RELATED APPLICATIONS

The present invention contains subject matter related to Japanese Patent Application No. 2007-328378 filed in the Japanese Patent Office on Dec. 20, 2007 and Japanese Patent Application No. 2008-300524 filed in the Japanese Patent Office on Nov. 26, 2008, the entire contents of which are incorporated herein by reference.

### BACKGROUND OF THE INVENTION

1. Field of the Invention

The present invention relates to a touch panel input device including a display unit and a touch panel provided on a screen of the display unit and operating an electronic apparatus by touching a display on the screen, a control method of the touch panel input device, a control program of the touch panel input device, and an electronic device.

2. Description of the Related Art

In general, a touch panel is provided on a screen of a liquid crystal display device or the like and is used as a pointing device. A resistance film type analog touch panel disclosed in JP-A-2004-213312 is known as such a touch panel.

In an electronic device such as a printer having such a touch panel, as shown in FIG. 5, plural buttons are displayed and thus one of the buttons should be touched to instruct an operation. For example, in FIG. 5, by first touching a button B11 of “plain paper” to select a sheet type, then touching a button B21 of “A4” to select a sheet size, and finally touching a button B32 of “non-bordered” to select a layout, an operating instruction is given to the electronic apparatus.

However, in the above-mentioned method, three buttons on the screen should be touched to instruct one operation.

### SUMMARY OF THE INVENTION

Accordingly, it is an object of the present invention to provide a technique for improving operability of a touch panel on which plural buttons are displayed.

A first aspect of the invention for accomplishing the above-mentioned object provides a touch panel input device having an image display unit and a touch panel, the touch panel input device including: a touch position detecting unit detecting a touch position on the touch panel; an option displaying unit displaying on the image display unit an image in which a plurality of option areas is established and each option area includes one or more options; and an option specifying unit specifying one option selected by an operator on the basis of the touch position detected by the touch position detecting unit, wherein when the touch position moves between the option areas with a touched state maintained, the option specifying unit specifies the option, which the touch position is first or finally detected from, among the options belonging to the option area which is a movement source as the option selected by the operator.

Here, in the touch panel input device, each option area may be set so that one of the options in the option area from which the touch position is first or finally detected is specified as the option selected by the operator.

In the touch panel input device, when the touch panel is changed from a non-touched state to a touched state, the option specifying unit may specify as the option selected by the operator the option from which the touch position is first detected among the options belonging to the option area from which the touch position is first detected.

In the touch panel input device, when the touch position moves from the inside of each option area to the outside, the option specifying unit may specify as the option selected by the operator the option from which the touch position is first or finally detected among the options in the option area.

In the touch panel input device, when the touch panel is changed from a touched state to a non-touched state, the option specifying unit may specify as the option selected by the operator the option from which the touch position is finally detected among the options belonging to the option area from which the touch position is finally detected.

In the touch panel input device, the option display unit may highlight the option specified as being selected by the operator.

A second aspect of the invention for accomplishing the above-mentioned object provides an electronic device having the above-mentioned touch panel input device.

A third aspect of the invention for accomplishing the above-mentioned object provides a control method of a touch panel input device having an image display unit and a touch panel, control method including: a touch position detecting step detecting a touch position on the touch panel; an option displaying step of displaying on the image display unit an image in which a plurality of option areas is established and each option area includes one or more options; and an option specifying step of specifying one option selected by an operator on the basis of the touch position detected in the touch position detecting step, wherein when the touch position moves between the option areas with a touched state maintained, the option specifying step includes specifying the option, which the touch position is first or finally detected from, among the options belonging to the option area which is a movement source as the option selected by the operator.

A fourth aspect of the invention for accomplishing the above-mentioned object provides a control program of a touch panel input device having an image display unit and a touch panel, the control program including: a touch position detecting step detecting a touch position on the touch panel; an option displaying step of displaying on the image display unit an image in which a plurality of option areas is established and each option area includes one or more options; and an option specifying step of specifying one option selected by an operator on the basis of the touch position detected in the touch position detecting step, wherein when the touch position moves between the option areas with a touched state maintained, the option specifying step includes specifying the option, which the touch position is first or finally detected from, among the options belonging to the option area which is a movement source as the option selected by the operator.

A fifth aspect of the invention for accomplishing the above-mentioned object provides a touch panel input device including: a touch panel operating unit including a display unit displaying an image inquiring an operation, a touch panel provided on a screen of the display unit, and a coordinate output unit outputting touched coordinates on the touch panel; a panel display unit displaying on the display unit the image inquiring an operation and including a plurality of areas and a plurality of buttons in the areas; an area specifying unit specifying the area including the coordinates at present; and a button specifying unit validating the button through which the coordinates first or finally pass among the plurality of buttons included in the area before the movement when the coordinates are changed from the present area to the different area by movement on the touch panel with a touched state maintained.

### BRIEF DESCRIPTION OF THE DRAWINGS

FIG. 1 is a block diagram illustrating a configuration of a touch panel input device according to a first embodiment of the invention.

FIG. 2 is a layout diagram illustrating a display example of the touch panel operating unit.

FIG. 3 is a flowchart illustrating an operation of the touch panel input device.

FIG. 4 is a diagram illustrating a change in operation of the touch panel input device.

FIG. 5 is a layout diagram illustrating a display example of a past touch panel operating unit.

1 . . . TOUCH PANEL INPUT DEVICE, 100 . . . TOUCH PANEL OPERATING UNIT, 110 . . . LCD, 120 . . . TOUCH PANEL, 130 . . . TOUCH PANEL CONTROLLER, 200 . . . HOST COMPUTER, 210 . . . CPU, 212 . . . PANEL DISPLAY UNIT, 214 . . . AREA SPECIFYING UNIT, 216 . . . BUTTON SPECIFYING UNIT, 220 . . . ROM, 230 . . . RAM, 240 . . . LCD CONTROLLER, 250 . . . PRINTER CONTROLLER, 260 . . . INTERNAL BUS, 1000 . . . PRINTER

### DESCRIPTION OF THE PREFERRED EMBODIMENTS

Hereinafter, a touch panel input device according to preferred embodiments of the invention will be described with reference to the accompanying drawings.

### First Embodiment

### Configuration of Touch Panel Input Device

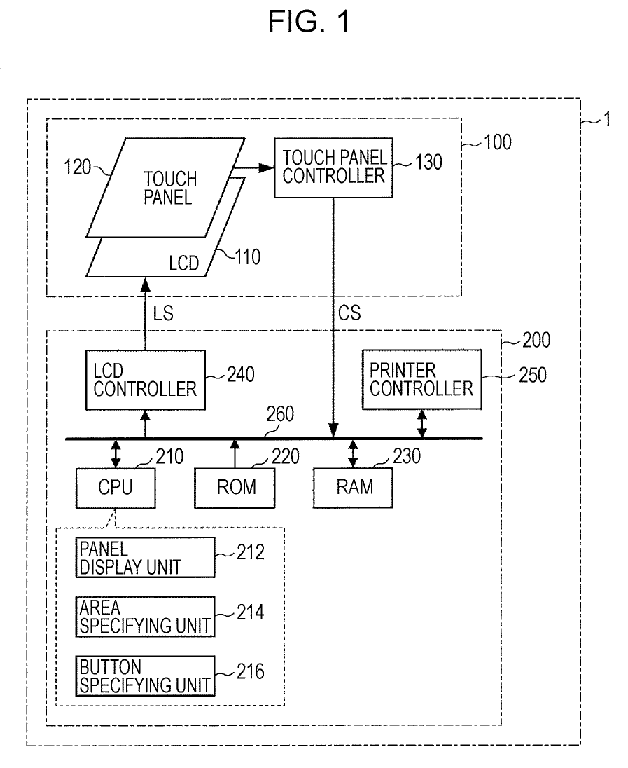

First, a configuration of a touch panel input device according to a first embodiment of the invention will be described with reference to FIG. 1. FIG. 1 is a block diagram illustrating a configuration of a touch panel input device according to a first embodiment of the invention.

As shown in FIG. 1, the touch panel input device 1 includes a touch panel operating unit 100 and a host computer 200.

The touch panel operating unit 100 includes a liquid crystal display (LCD) panel 110 as a display unit displaying an image inquiring an operation, a touch panel 120 disposed on a screen of the LCD panel 110, and a touch panel controller 130 as a coordinate output unit outputting a coordinate signal CS indicating touched coordinates on the touch panel 120.

In the host computer 200, a CPU 210, a ROM 220, a RAM 230, an LCD controller 240 outputting a control signal LS for controlling the LCD panel 110, and a printer controller 250 controlling a printer when an electronic apparatus is the printer are connected to each other through an internal bus 260. The coordinate signal CS output from the touch panel controller 130 is connected to the internal bus 260. The CPU 210 reads and executes a control program including a panel display unit 212, an area specifying unit 214, and a button specifying unit 216 and being stored in the ROM 220.

### Display Example of Touch Panel Operating Unit

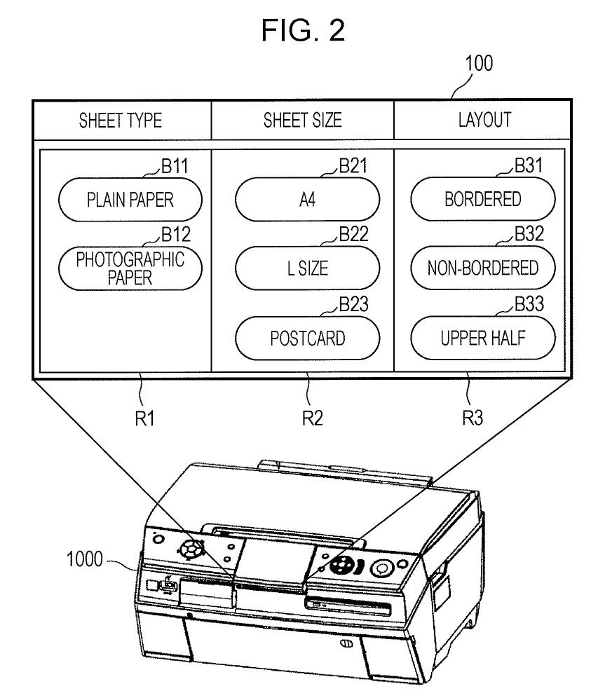

A display example of the touch panel operating unit will be described now with reference to FIG. 2. FIG. 2 is a layout diagram illustrating a display example of the touch panel operating unit.

A printer 1000 as an electronic device includes a touch panel operating unit 100 shown in FIG. 2 as an example of an operation panel. In the touch panel operating unit 100, (plural=) three areas R1, R2, and R3 are displayed on a screen of the LCD panel 110 by a panel display unit 212, (plural=) two buttons B11 and B12 are displayed in the area R1, (plural=) three buttons B21, B22, and B23 are displayed in the area R2, and (plural=) three buttons B31, B32, and B33 are displayed in the area R3.

The buttons in the area R1 are used to select a sheet type. The “plain paper” is selected when the button B11 is selected and the “photographic paper” is selected when the button B12 is selected. The buttons in the area R2 are used to select a sheet size. The “A4” is selected when the button B21 is selected, the “L size” is selected when the button B22 is selected, and the “postcard” is selected when the button B23 is selected. The buttons in the area R3 are used to select a layout. The “bordered” is selected when the button B31 is selected, the “non-bordered” is selected when the button B32 is selected, and the “upper half” is selected when the button B33 is selected.

An area specifying unit 214 specifies an area to which a coordinate value included in a coordinate signal CS belongs at present. A button specifying unit 216 specifies a button through which the coordinate value passes, and validates the button through which the coordinate value first or finally passes among the buttons included in the area before movement when the coordinate value is changed from the present area to a different area.

### Operation of Touch Panel Input Device

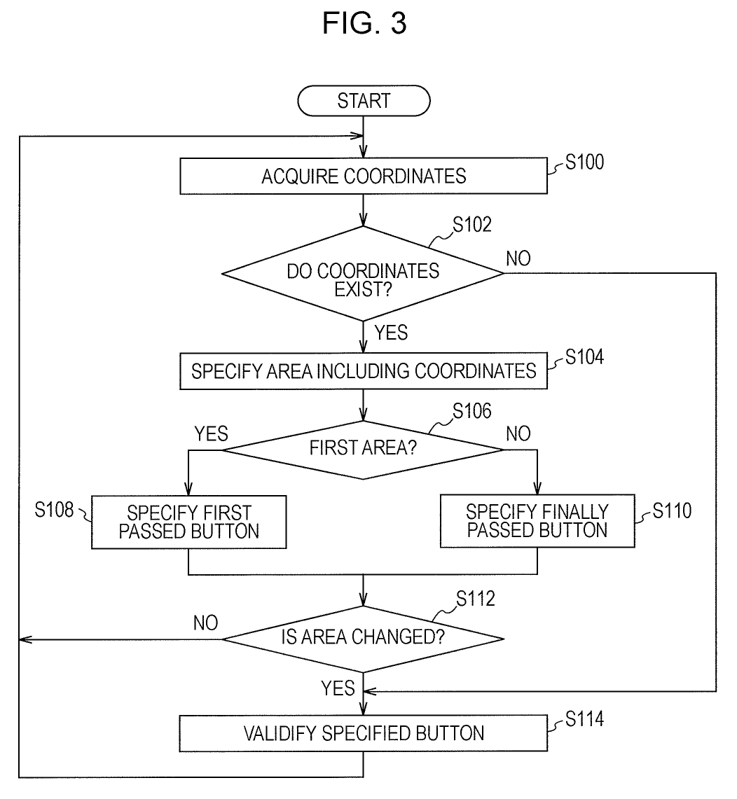

An operation of the touch panel input device will be described now with reference to FIG. 3. FIG. 3 is a flowchart illustrating an operation of the touch panel input device. In this embodiment, it is assumed that the button specifying unit 216 is set to validate the button through which a finger or the like first passes in the first touched area on the touch panel 120 and to validate the button through which the finger or the like finally passes in the other areas.

First, in step S100, a coordinate signal CS is acquired by the touch panel controller 130.

Then, in step S102, it is determined whether the coordinate signal CS exists (whether the touch panel 120 is touched by a finger or the like. When the coordinate signal CS exists (a touched state), the process of step S104 is performed. When the coordinate signal CS does not exist (a non-touched state), the process of step S114 is performed.

Then, in step S104, one of the areas R1 to R3 including the coordinate value of the coordinate signal CS is specified by the area specifying unit 214.

Then, in step S106, it is determined whether the area specified by the area specifying unit 214 is a first specified area. When the area is a first specified area, the process of step S108 is performed. When the area is not a first specified area, the process of step S110 is performed.

Then, in step S108, the button specifying unit 216 monitors that the coordinate value passes through the buttons and specifies the button through which the coordinate value first passes. Then, the process of step S112 is performed.

On the other hand, in step S110, the button specifying unit 216 monitors that the coordinate value passes through the buttons and specifies the button through which the coordinate value finally passes. Then, the process of step S112 is performed.

In step S112, it is determined whether the area is changed. When the area is changed, the process of step S114 is performed. When the area is not changed, the process of step S100 is performed.

Then, in step S114, the button specified by the button specifying unit 216 is validated and the process of step S100 is performed. When the procedure goes from step S102 to this step, it can be determined that the finger or the like is detached from the touch panel 120.

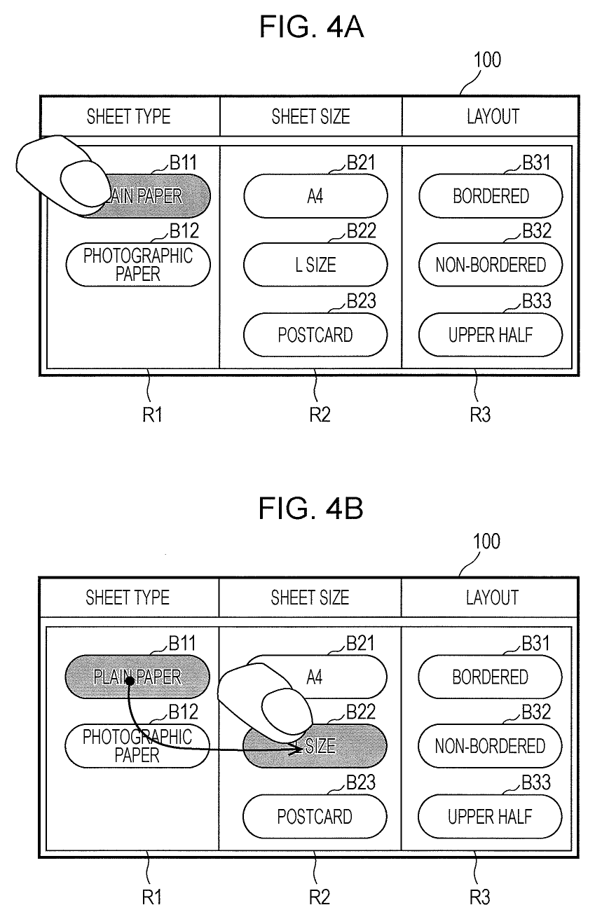

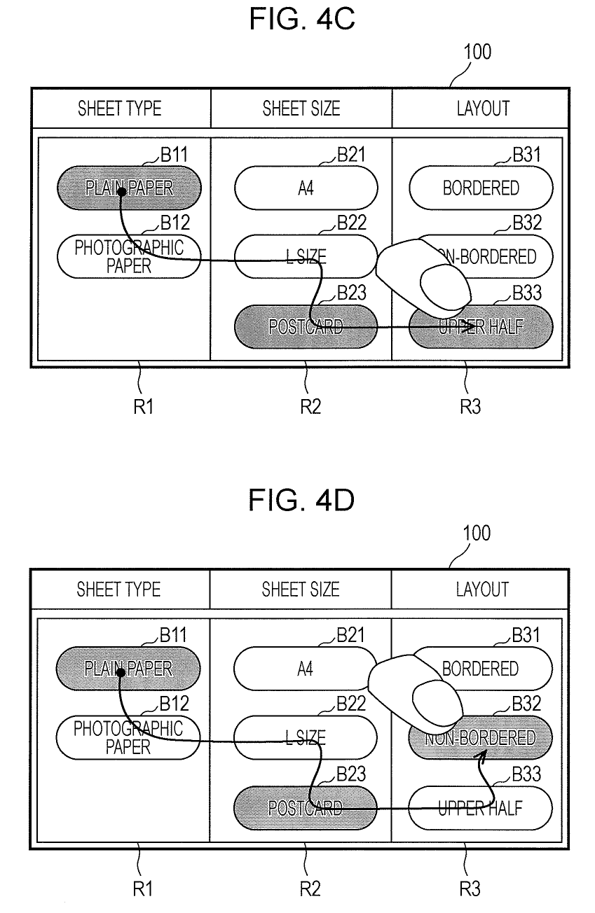

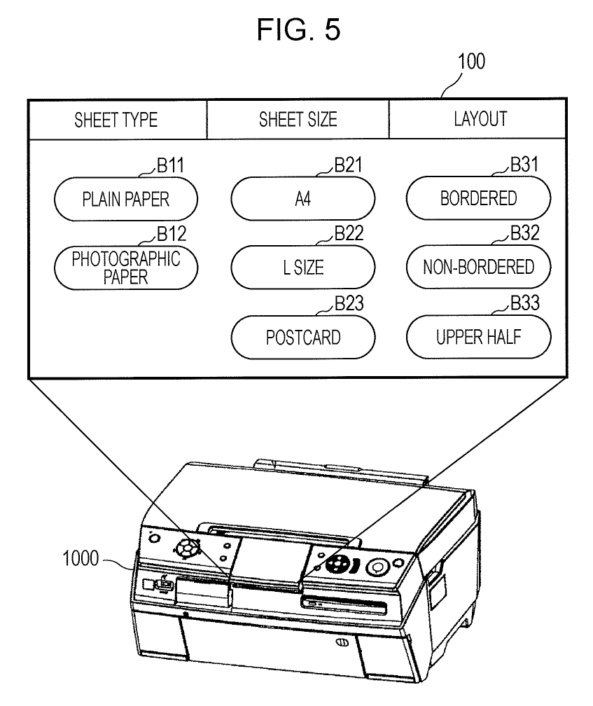

An operation of the touch panel input device will be described with reference to FIG. 4. FIG. 4 is a diagram illustrating a change in operation of the touch panel input device. FIG. 4 shows an example where the sheet type is set to the “plain paper”, the sheet size is set to the “L size”, and the layout is set to the “non-bordered.”

First, as shown in FIG. 4(A), the button B11 of “plain paper” included in the area R1 of the touch panel operating unit 100 is touched with the finger or the like to select the sheet type. Since the first passed button is validated in the area R1, the button B11 of “plain paper” is highlighted.

As shown in FIG. 4(B), the finger moves from the area R1 to the area R2 to select the sheet size with the finger not detached from the touch panel operating unit 100 and the finger passes through the button B22 of “L size.” The finally passed button is validated in the areas R2 and R3 and the button B22 of “L size” through which the finger is passing at present is highlighted at the time shown in FIG. 4(B).

Then, as shown in FIG. 4(C), to set the sheet size to the “postcard”, the finger moves from the area R2 to the area R3 through the button B22 of “L size” and the button B23 of “postcard” and passes through the button B33 of “upper half.” At the time of moving from the area R2 to the area R3, the button B23 of “postcard” through which the finger finally passes in the area R2 is validated and highlighted.

Then, as shown in FIG. 4(D), to set the layout to the “non-bordered”, the finger is detached from the touch panel operating unit 100 when passing through the button B33 of “upper half” and the button B32 of “non-bordered.” At this time, the button B32 of “non-bordered” is validated and highlighted.

As shown in FIG. 4, by allowing the finger to touch the button B11 of “plain paper” on the touch panel operating unit 100, to pass over the button B23 of “postcard” and the button B32 of “non-bordered” without detaching the finger, and then detaching the finger therefrom, three buttons can be selected with one touching operation.

According to the above-mentioned embodiment, the following advantages are obtained.

In this embodiment, since plural buttons can be selected by allowing a finger or the like to move with the touch panel pressed, it is possible to improve the operability. Since the selected buttons are highlighted, an erroneous operation can be prevented. It is also possible to provide an electronic device with improved operability.

While the touch panel input device has been described with reference to the embodiment, the invention is not limited to the embodiment, but can be modified in various forms without departing from the gist of the invention. Modified examples will be described now.

### Modified Example 1

Modified example 1 of the touch panel input device will be described. Although it has been described in the above-mentioned first embodiment that the first passed button is validated in the area first touched with the finger and the finally passed button is validated in the other areas, other settings can be made. For example, the first passed button may be validated in all the areas or the finally passed button may be validated in all areas and other combinations may be considered. One of the first or finally passed buttons may be validated in the respective areas. This setting is instructed by an operator using a setting picture displayed on the touch panel operating unit 100. Although three areas have been exemplified, two areas or four or more areas may be provided. The number of buttons included in one area may be one.

### Modified Example 2

Modified example 2 of the touch panel input device will be described now. Although it has been described in the above-mentioned first embodiment that the touch panel is established on the screen of the LCD panel 110 as the touch panel operating unit 100 and is operated with a finger, the touch panel may be connected to a personal computer using a pen doublet or a mouse and the touch panel input device may be embodied by a program displaying an operation panel on a display.

1. A touch panel input device having an image display unit and a touch panel, the touch panel input device comprising:
a touch position detecting unit detecting a touch position on the touch panel;
an option displaying unit displaying on the image display unit an image in which a plurality of option areas is established and each option area includes one or more options; and
an option specifying unit specifying one option selected by an operator on the basis of the touch position detected by the touch position detecting unit,
wherein when the touch position moves between the option areas with a touched state maintained, the option specifying unit specifies the option, which the touch position is first or finally detected from, among the options belonging to the option area which is a movement source as the option selected by the operator.

2. The touch panel input device according to claim 1, wherein each option area is set so that one of the options in the option area from which the touch position is first or finally detected is specified as the option selected by the operator.

3. The touch panel input device according to claim 1, wherein when the touch position moves from the inside of each option area to the outside, the option specifying unit specifies as the option selected by the operator the option from which the touch position is first or finally detected among the options in the option area.

4. The touch panel input device according to claim 1, wherein when the touch panel is changed from a non-touched state to a touched state, the option specifying unit specifies as the option selected by the operator the option from which the touch position is first detected among the options belonging to the option area from which the touch position is first detected.

5. The touch panel input device according to claim 1, wherein when the touch panel is changed from a touched state to a non-touched state, the option specifying unit specifies as the option selected by the operator the option from which the touch position is finally detected among the options belonging to the option area from which the touch position is finally detected.

6. The touch panel input device according to claim 1, wherein the option display unit highlights the option specified as being selected by the operator.

7. An electronic device comprising the touch panel input device according to claim 1.

8. A control method of a touch panel input device having an image display unit and a touch panel, control method comprising:
a touch position detecting step detecting a touch position on the touch panel;
an option displaying step of displaying on the image display unit an image in which a plurality of option areas is established and each option area includes one or more options; and
an option specifying step of specifying one option selected by an operator on the basis of the touch position detected in the touch position detecting step,
wherein when the touch position moves between the option areas with a touched state maintained, the option specifying step includes specifying the option, which the touch position is first or finally detected from, among the options belonging to the option area which is a movement source as the option selected by the operator.

9. (canceled)

10. A touch panel input device comprising:
a touch panel operating unit including a display unit displaying an image inquiring an operation, a touch panel provided on a screen of the display unit, and a coordinate output unit outputting touched coordinates on the touch panel;
a panel display unit displaying on the display unit the image inquiring an operation and including a plurality of areas and a plurality of buttons in the areas;
an area specifying unit specifying the area including the coordinates at present; and
a button specifying unit validating the button through which the coordinates first or finally pass among the plurality of buttons included in the area before the movement when the coordinates are changed from the present area to the different area by movement on the touch panel with a touched state maintained.
